(19) United States
(12) Patent Application Publication
(10) Pub. No.: US 2006/0010439 A1
(43) Pub. Date: Jan. 12, 2006

(54) Conflict detection in rule sets

(76) Inventor: Andrei Majidian, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/531,054

(22) PCT Filed: Oct. 24, 2003
(86) PCT No.: PCT/GB03/04599

§ 371 Date: Apr. 12, 2005

(30) Foreign Application Priority Data
Oct. 29, 2002 (GB) 0225143.7

(51) Int. Cl. G06F 9/455

(52) U.S. Cl. 718/1

(57) ABSTRACT

The invention provides a method and system for detecting conflicts in policy-based management rule sets. This is achieved by expanding a set of input rules such that each rule relates only to one subject performing one action on a single object, and is known as a singleton rule. Then, data defining the semantic relationships between the different actions is received, and this is used to further expand the singleton rules to give a complete rule set defining every possible rule according to the semantic relationships between rules. This complete set can the be processed to detect conflicts between two or more rules, and any conflicting rules are identified and displayed to a user. Additionally, the invention also provides that the rule sets may be reduced to a canonical form for compact representation thereof.

### TECHNICAL FIELD

The present invention relates to a method and system for identifying conflicts in a set of system operating rules. Moreover, in another aspect the invention further relates to minimising a set of system operating rules to its optimum form. Furthermore, the invention also relates to a method and system operating in accordance with a rule set generated by the earlier aspects.

### BACKGROUND TO THE INVENTION AND PRIOR ART

Modern systems are dynamic and scalable i.e. they expand and contract in terms of the functionality they offer. As a system grows the functionality on offer increases and the interrelationships between the different functions become more complex. Different parts of the system may be owned by different entities. A global knowledge of the interrelationships between the functions within this dynamic system currently resides outside the system in the people responsible for it. Eventually the system reaches a point beyond the grasp of the average operator, and some other form of global system awareness is required.

Frequently systems are governed by a set of operating rules. Examples of such rules are file read/write permissions provided by operating systems such as Unix™ or Windows®. Other similar examples are internet, world-wide-web, or email access permissions, or, more differently, rules defining the operation of an expert system designed for a particular task. Moreover, such rules may also encompass rules or regulations which apply to humans in their daily lives, for example, rules or regulations at their place of work, responsibilities they have, duties to others, etc.

In such rule-based systems, the addition of a new rule may give rise to conflict with existing rules. In some cases this may be obvious (e.g. direct contradiction, such as where a user of a file-sharing system has permission to write to a particular file but not to read that file). In other cases, where the conflict is a result of complex relationships between the functionality on offer, the conflict cannot be detected automatically because the system has no knowledge about the interrelationships between the functions. This can lead to complicated situations which require resolution. In technical systems such conflicts can lead to errors and potential catastrophic failures.

### SUMMARY OF THE INVENTION

The present invention aims to address the above problems by providing a method and system for analysing a set of rules so as to detect potential conflicts between the operational rules. This is achieved in the invention by adding knowledge about the interrelationships between system functions, such that the method and system provided by the invention may then automatically detect and indicate potential conflicts to a user. Additionally, the invention also relates to a system arranged to operate in accordance with a rule set generated by the above, and a method of operating a system using such a rule set.

In view of the above, from a first aspect the present invention provides a method of identifying conflicts in a set of system operating rules, comprising the steps of:—
a) storing rule data representing a set of one or more system operating rules, each rule comprising at least one system command;
b) receiving semantic data representing a graph structure of hierarchical semantic relationships between available system commands, including those in the set of system operating rules;
c) expanding the system operating rules according to the allowable hierarchical semantic relationships between the available system command portions, to give, for any particular system operating rule, an additional system operating rule for each hierarchical semantic level in the graph structure below the system command present in the particular rule; and
d) comparing the expanded system rules to identify those rules for which a semantic conflict occurs therebetween.

The invention provides the advantage that conflicts within a rule set can be identified in a systematic and reliable way. Moreover the provision of the semantic data allows a computer or other machine performing the invention to interpret the system rules consistently in accordance with the relative meanings placed thereon by the semantic data. This whilst such a machine can never understand the actual meanings of the rules, the semantic data by representing the semantic relationships between the various possible rules allows such a machine to understand the relative semantics between each rule.

Preferably, each stored rule comprises a subject portion identifying one or more system users, a system command portion identifying the system command to which the rule relates, and an object portion identifying one or more system objects to which the rule applies. By providing the rules in such a standard format, the interpretation of the relative meanings thereof is rendered easier.

In the preferred embodiment, when any of the system rules identify more than one system users in the subject portion, and/or more than one system objects in the object portion, the method further comprises expanding such rules to produce replacement rules having a single system user in the subject portion, and a single system object in the object portion, said replacement rules being produced before the expansion step c) is performed. Such features allow for rules which deal with multiple subjects and/or objects to be expanded out to produce additional such rules, each dealing only with a single subject and object. This is a necessary preparatory step to the main expansion according to the hierarchical semantic data in the case where rules are present with multiple subjects and/or objects.

Moreover, within the preferred embodiment each stored rule preferably further comprises a positive indication portion, which indicates whether the rule is to be applied positively or negatively. This allows the same set of system commands to be applied over a broader range of activities, by permitting the rule to specify whether the command can or cannot be performed by a particular subject or group of subjects to a particular object or group of objects.

In addition, in the preferred embodiment there is further preferably provided the step of producing from the semantic data a second graph structure corresponding to the inverse of the hierarchical semantic relationships between the available system commands, and wherein the expanding step c) uses the hierarchical semantic relationships of the second graph structure to expand any rules for which the positive indication portion thereof indicates are to be applied negatively. This is particularly advantageous, as it means that the same graph processing algorithms may be used for both negative and positive rules.

From a second aspect there is further provided a method of generating a set of system operating rules from an initial set of system operating rules, comprising the steps of:
identifying conflicts in the initial set of system operating rules using the method of the first aspect; and
resolving any identified conflicts in the expanded set of initial rules to give a resolved expanded set of system operating rules.

The second aspect therefore provides a set of system operating rules for which the conflicts have been resolved, resulting in improves operation of a system running in accordance with the generated rules.

Preferably, within embodiments of the second aspect there is further provided the step of reducing the resolved expanded set of initial rules to canonical form to give an optimised set of system operating rules. With this feature the advantage is provided that a reduced set of system rules which encompass the system commands of the original rule set is obtained, which require less storage space, and less processing in use.

In accordance with a third aspect of the invention there is further provided a method of operating a system comprising applying the set of system operating rules generated by the second aspect in the system operation.

From a further aspect there is provided a computer program arranged such that when executed by a computer it causes the computer to perform the method of any of the first or second aspects.

Moreover, from a yet further aspect there is also provided a computer readable storage medium storing a computer program according to the further aspect. In the yet further aspect the computer readable storage medium may be any magnetic, optical, magneto-optical, solid state, volatile, non-volatile, or any other suitable computer program storage medium known in the art.

In addition to the above, from a sixth aspect there is also provided a system for identifying conflicts in a set of system operating rules, comprising:—
a) storage means for storing rule data representing a set of one or more system operating rules, each rule comprising at least one system command;
b) data receiving means for receiving semantic data representing a graph structure of hierarchical semantic relationships between available system commands, including those in the set of system operating rules; and
c) processing means operable to:
   expand the system operating rules according to the allowable hierarchical semantic relationships between the available system command portions, to give, for any particular system operating rule, an additional system operating rule for each hierarchical semantic level in the graph structure below the system command present in the particular rule; and
   compare the expanded system rules to identify those rules for which a semantic conflict occurs therebetween.

Additionally, from a further aspect the invention further provides a system for generating a set of system operating rules from an initial set of system operating rules, comprising:
the system of the sixth aspect; and further comprising processing means arranged to:
   resolve any identified conflicts in the expanded set of initial rules to give a resolved expanded set of system operating rules.

Preferably, within the seventh aspect the processing means is further arranged to reduce the resolved expanded set of initial rules to canonical form to give an optimised set of system operating rules.

Finally, from yet another aspect there is also provided a system arranged to operate in accordance with a set of system operating rules generated by the seventh aspect.

Within the sixth and seventh aspects the corresponding further features and advantages as previously respectively described in respect of the first and second aspects may be obtained.

### DESCRIPTION OF THE DRAWINGS

Further features and advantages of the present invention will become apparent from the following description of embodiments thereof, presented by way of example only, and by reference to the accompanying drawings, wherein like reference numerals refer to like parts, and wherein:—

FIG. 1 is a block diagram showing the process of a conventional policy-based management code generator;

FIG. 2 is a flow diagram showing the additional step provided by an embodiment of the invention;

FIG. 3 is a drawing of a computer system which forms the hardware for an embodiment of the invention;

FIG. 4 is a system architectural block diagram of the internal components of the computer system of FIG. 3;

FIG. 5 is block diagram of the programs forming the embodiment of the invention stored on a hard drive of the computer system;

FIG. 6 is a flow diagram illustrating the steps involved in the operation of an embodiment of the invention;

FIG. 7 is an abstract syntax tree of a set of rules used as input to an embodiment of the invention;

FIG. 8 is an abstract syntax tree illustrating a singleton rule;

FIG. 9 is a conceptual block diagram illustrating the storage of semantic representation data in a computer memory;

FIG. 10 is a first type of semantic graph used in the embodiments of the invention;

FIG. 11 is a second type of semantic graph used in the embodiments of the invention;

FIG. 12 is another type of semantic graph used in the embodiments of the invention;

FIG. 13 is yet another type of semantic graph used in the embodiments of the invention;

FIG. 14 illustrates a semantic graph referred to in one of the examples describing an embodiment of the invention;

FIG. 15 illustrates a semantic graph referred to in one of the examples describing an embodiment of the invention;

FIG. 16 is a block diagram of system components used in an embodiment of the invention which provides a dynamic approach to PBM;

FIG. 17 is a semantic graph referred to in one of the examples describing an embodiment of the invention; and

FIG. 18 is a semantic graph referred to in one of the examples describing an embodiment of the invention.

### Overview of the Embodiments

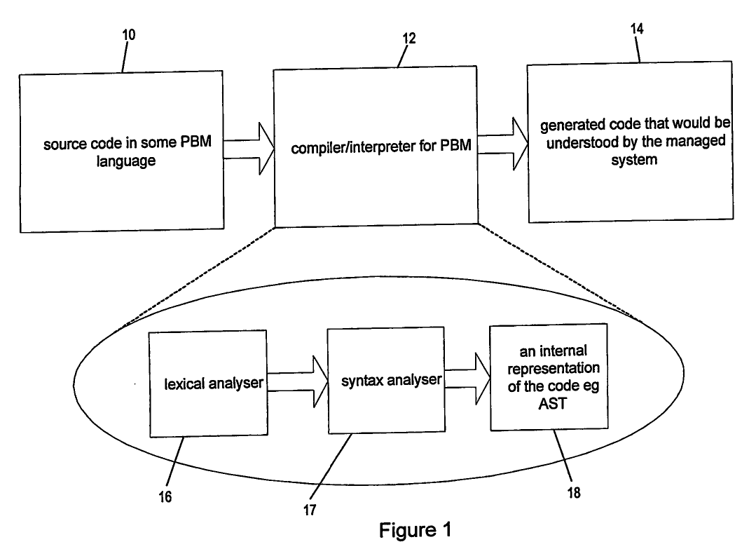

FIG. 1 illustrates the usual steps involved in the production and coding of system rules. Schematically, compilation/interpretation can be depicted as follows. The policy is written in a policy-based management (PBM) language (10). The system then compiles/interprets this source code (12), and then generates appropriate code that can be understood by the underlying system (14) (i.e. the system that is being managed by the policy-based management system). As part of the compilation and interpretation step, the source code is first subject to lexical analysis (16), and then semantic analysis (17). Next, an internal representation of the code is produced eg in AST (18).

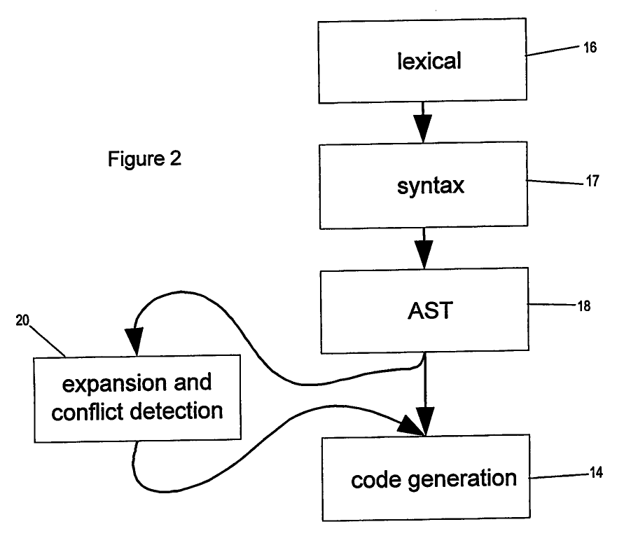

FIG. 2 illustrates the additional processing performed by the embodiments of the present invention, at (20). What this phase does is to use semantic ordering information to expand the existing code to its full and semantically coherent extent, and this expanded code is then passed to the original code generation phase of the PBM system to generate code for the full expanded rule set.

The above is achieved by the embodiment of the invention capturing information about the semantic relationship between functions. The system captures the relationships inherent between the functions in the mathematical model of a partially ordered set (poset). Notice that these relationships, although they reside in the semantics, are not part of the functionality provided by current systems. Nor do current systems have any awareness of these relationships, they exist only in the minds of the programmers. The invention captures this knowledge and brings it into the system via this mathematical model of the poset.

Having gained knowledge of the functions' interrelationships, the system is able, through an algorithm provided by the embodiment of the invention, to generate the full implications of what rules are applicable to which entities. The algorithm uses the aforementioned poset structure to generate these implications.

Conflict is preferably identified statically i.e. at compile time (when rules are added to the rule base) and not, as is currently the case, dynamically i.e. at run time (when rules are enforced), resulting in system problems. Because the system of the embodiment can generate the full implications of each rule added to a system, the embodiment of the invention makes it easy to detect mechanically any conflict that previously would have been impossible to detect because of the conflict lying hidden within the semantics.

In addition, having detected any potential conflicts and performed a process of conflict resolution, the embodiment of the invention is then able to condense a set of rules into a minimum number of rules that would have the same implications as the original set. This again makes use of the poset structure. To do this, the invention provides a formula that computes the minimum set.

Moreover, the invention is also intended to cover a system and its associated method of operation which operates in accordance with a set of system operating rules which have had their conflicts resolved in accordance with the principles of the invention. Here the resolved rule set may in either an expanded or canonical form.

### DESCRIPTION OF THE EMBODIMENT

Having described an overview of the invention, a full description of an embodiment thereof will now be described.

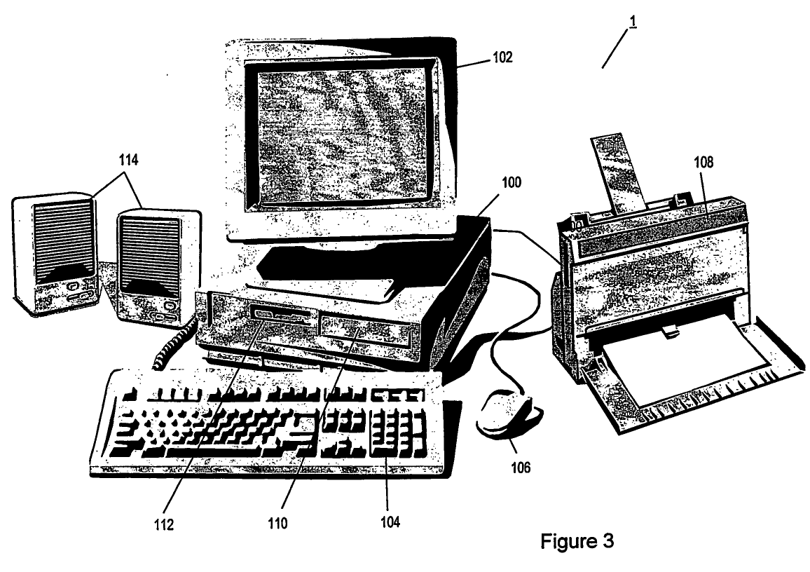

FIG. 3 illustrates a general purpose computer system which provides the operating environment of the embodiment of the present invention. Later, the operation of the invention will be described in the general context of computer executable instructions, such as program modules, being executed by a computer. Such program modules may include processes, programs, objects, components, data structures, data variables, or the like that perform tasks or implement particular abstract data types. Moreover, it should be understood by the intended reader that the invention may be embodied within other computer systems other than those shown in FIG. 3, and in particular hand held devices, notebook computers, main frame computers, mini computers, multi processor systems, distributed systems, etc. Within a distributed computing environment, multiple computer systems may be connected to a communications network and individual program modules of the invention may be distributed amongst the computer systems.

With specific reference to FIG. 3, a general purpose computer system 1 which may form the operating environment of the embodiment of the invention, and which is generally known in the art comprises a desk-top chassis base unit 100 within which is contained the computer power unit, mother board, hard disk drive or drives, system memory, graphics and sound cards, as well as various input and output interfaces. Furthermore, the chassis also provides a housing for an optical disk drive 110 which is capable of reading from and/or writing to a removable optical disk such as a CD, CDR, CDRW, DVD, or the like. Furthermore, the chassis unit 100 also houses a magnetic floppy disk drive 112 capable of accepting and reading from and/or writing to magnetic floppy disks. The base chassis unit 100 also has provided on the back thereof numerous input and output ports for peripherals such as a monitor 102 used to provide a visual display to the user, a printer 108 which may be used to provide paper copies of computer output, and speakers 114 for producing an audio output. A user may input data and commands to the computer system via a keyboard 104, or a pointing device such as the mouse 106.

It will be appreciated that FIG. 3 illustrates an exemplary embodiment only, and that other configurations of computer systems are possible which can be used with the present invention. In particular, the base chassis unit 100 may be in a tower configuration, or alternatively the computer system 1 may be portable in that it is embodied in a lap-top or note-book configuration. Other configurations such as personal digital assistants or even mobile phones may also be possible.

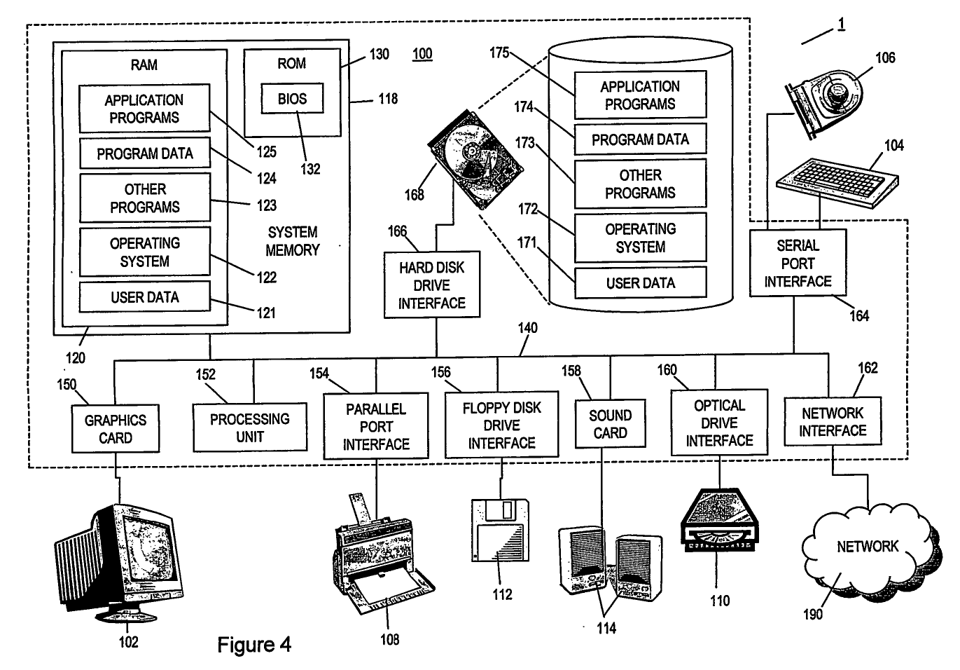

FIG. 4 illustrates a system block diagram of the system components of the computer system 1. Those system components located within the dotted lines are those which would normally be found within the chassis unit 100.

With reference to FIG. 2, the internal components of the computer system 1 include a mother board upon which is mounted system memory 118 which itself comprises random access memory 120, and read only memory 130. In addition, a system bus 140 is provided which couples various system components including the system memory 118 with a processing unit 152. Also coupled to the system bus 140 are a graphics card 150 for providing a video output to the monitor 102; a parallel port interface 154 which provides an input and output interface to the system and in this embodiment provides a control output to the printer 108; and a floppy disk drive interface 156 which controls the floppy disk drive 112 so as to read data from any floppy disk inserted therein, or to write data thereto. In addition, also coupled to the system bus 140 are a sound card 158 which provides an audio output signal to the speakers 114; an optical drive interface 160 which controls the optical disk drive 110 so as to read data from and write data to a removable optical disk inserted therein; and a serial port interface 164, which, similar to the parallel port interface 154, provides an input and output interface to and from the system. In this case, the serial port interface provides an input port for the keyboard 104, and the pointing device 106, which may be a track ball, mouse, or the like.

Additionally coupled to the system bus 140 is a network interface 162 in the form of a network card or the like arranged to allow the computer system 1 to communicate with other computer systems over a network 190. The network 190 may be a local area network, wide area network, local wireless network, or the like. The network interface 162 allows the computer system 1 to form logical connections over the network 190 with other computer systems such as servers, routers, or peer-level computers, for the exchange of programs or data.

In addition, there is also provided a hard disk drive interface 166 which is coupled to the system bus 140, and which controls the reading from and writing to of data or programs from or to a hard disk drive 168. All of the hard disk drive 168, optical disks used with the optical drive 110, or floppy disks used with the floppy disk 112 provide non-volatile storage of computer readable instructions, data structures, program modules, and other data for the computer system 1. Although these three specific types of computer readable storage media have been described here, it will be understood by the intended reader that other types of computer readable media which can store data may be used, and in particular magnetic cassettes, flash memory cards, tape storage drives, digital versatile disks, or the like.

Each of the computer readable storage media such as the hard disk drive 168, or any floppy disks or optical disks, may store a variety of programs, program modules, or data. In particular, the hard disk drive 168 in the embodiment particularly stores a number of application programs 175, application program data 174, other programs required by the computer system 1 or the user 173, a computer system operating system 172 such as Microsoft® Windows®, Linux™, Unix™, or the like, as well as user data in the form of files, data structures, or other data 171. The hard disk drive 168 provides non volatile storage of the aforementioned programs and data such that the programs and data can be permanently stored without power.

In order for the computer system 1 to make use of the application programs or data stored on the hard disk drive 168, or other computer readable storage media, the system memory 118 provides the random access memory 120, which provides memory storage for the application programs, program data, other programs, operating systems, and user data, when required by the computer system 1. When these programs and data are loaded in the random access memory 120, a specific portion of the memory 125 will hold the application programs, another portion 124 may hold the program data, a third portion 123 the other programs, a fourth portion 122 the operating system, and a fifth portion 121 may hold the user data. It will be understood by the intended reader that the various programs and data may be moved in and out of the random access memory 120 by the computer system as required. More particularly, where a program or data is not being used by the computer system, then it is likely that it will not be stored in the random access memory 120, but instead will be returned to non-volatile storage on the hard disk 168.

The system memory 118 also provides read only memory 130, which provides memory storage for the basic input and output system (BIOS) containing the basic information and commands to transfer information between the system elements within the computer system 1. The BIOS is essential at system start-up, in order to provide basic information as to how the various system elements communicate with each other and allow for the system to boot-up.

Whilst FIG. 4 illustrates one embodiment of the invention, it will be understood by the skilled man that other peripheral devices may be attached to the computer system, such as, for example, microphones, joysticks, game pads, scanners, or the like. In addition, with respect to the network interface 162, we have previously described how this is preferably a network card, although equally it should also be understood that the computer system 1 may be provided with a modem attached to either of the serial port interface 164 or the parallel port interface 154, and which is arranged to form logical connections from the computer system 1 to other computers via the public switched telephone network (PSTN).

Where the computer system 1 is used in a network environment, it should further be understood that the application programs, other programs, and other data which may be stored locally in the computer system may also be stored, either alternatively or additionally, on remote computers, and accessed by the computer system 1 by logical connections formed over the network 190.

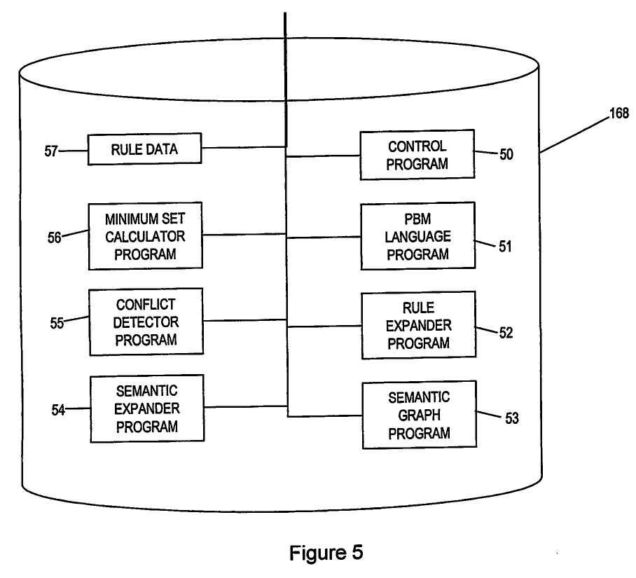

FIG. 5 illustrates the hard disk drive 168, and the specific programs which are stored thereon provided by the embodiment of the invention. Such programs may be stored in the application programs area 175 of the hard disk, or in the other programs area 173. Where data is stored (as opposed to an executable program), this is preferably stored in the program data area 174.

The specific embodiment provides several programs which are each arranged to control the computer to perform the invention. Firstly, a control program 50 is provided, which provides a user interface to allow control of the embodiment, and which also acts as a central control process which launches the other programs and passes data to and receives data from as required. The operation of the other programs as controlled by the control program 50 will be described later.

Secondly, a policy-based management (PBM) language program 51 is provided, which provides the functionality to allow the system rules to be expressed in a machine readable PBM. Next, a rule expander program 52 is also provided, which acts to work on the system rules to expand them as required, as will become apparent later. Fourthly, a semantic graph program 53 is provided, which allows semantic meanings between rules to be expressed in a machine readable form.

A semantic expander program 54 is next provided, which acts to use the semantic graph data to expand a rule to give all its semantically equivalent rules. Moreover, a conflict detector program 55 is further provided to perform conflict detection on the semantically expanded rules. Finally, a minimum set calculator program 56 is also provided to perform calculations of minimum rules sets, where possible.

In addition to the above programs, rule data 57 is also provided, which stores the data defining the system rules, both in their initial, intermediate, and final forms as appropriate.

It should be further understood that although the programs mentioned above have been described as being stored on the hard disk 168, they may equally be stored on any other data storage medium, such as an optical disk, tape drive, or the like.

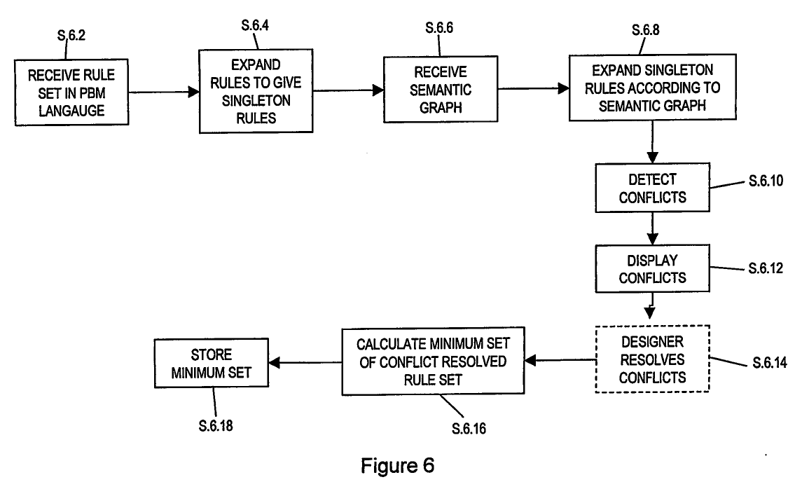

The operation of the individual programs will now be described, with reference to FIG. 6, which displays the overall operation of the embodiment of the invention in flow diagram form.

The embodiment of the invention uses the control program 50 to co-ordinate its processing. Therefore, imagine a user using the computer system 1 has launched the control program 50, and is presented with a user interface presented thereby.

Firstly, at step 6.2 the system rule set which is to be processed is entered into the computer by the user, either by loading from disk, over a network, or via the keyboard. We have produced a PBM language which allows such system rules to be expressed in machine-readable form, and which we call Joey. The control program 50 therefore starts the PBM language program 51, which provides the functionality to allow a user to enter the rule set in Joey.

The language Joey was developed as a generic language in order to easily allow rules to be expressed in a form that allows for direct and unambiguous expansion thereof (see later). Joey was developed with just enough features to demonstrate the concept of semantic ordering of actions. The concepts that are demonstrated here with Joey can easily be adapted into any policy-based language. This is because all policy-based languages must have the basic structure of Joey.

All policy based languages have to have the notion of positive or negative authorisation. The notion of obligation or task setting, be it positive or negative, for a subject is not a universal notion, however for the sake of generality it has been included in Joey. Although they may be referred to differently in different languages the concepts remain the same. Additionally all languages will have actors (here referred to as subjects) which act upon targets (here referred to as objects) and the functionality the system provides (here referred to as verbs).

There are other concepts, for example many languages have the concept of time, however, these are not considered as essential concepts in order to demonstrate semantic ordering of actions.

The following is a BNF-esque description of Joey:—

<policy> ::= (<rule>)*
<rule> ::= <ruleHeader> “:” <ruleBody> “;”
<ruleHeader> ::= <polarity> <ruleType>
<polarity> ::= “positive” | “negative”
<ruleType> ::= “authorisation” | “obligation”
<ruleBody> ::= <subjectSet> <verbSet> <objectSet>
<subjectSet> ::= “{“ <commaSeparatedList> ”}”
<commaSeparatedList> ::= <identifier > (“,” <identifier >)*
<objectSet> ::= “{“ <commaSeparatedList> ”}”
<verbSet> ::= “{“ <verbList> ”}”
<verbList> ::= <verb> (“,” <verb>)*
<verb> ::= <identifier> “(“ <parameterList> ”)”
<parameterList> ::= “(<commaSeparatedList>)”

where <identifier> is defined as identifier in languages such as Java, C and C++.

Given the language Joey, as defined above, as an example consider the following policy:

negative authorisation : {alex, danny} {read( )} {hamlet}
positive obligation : alex {send( )} {hamlet}

which translates to:
i) neither Alex nor Danny are allowed to read Hamlet; and
ii) Alex has a positive obligation to send Hamlet.

Clearly such a policy provides conflicting rules, as Alex is not allowed to read Hamlet, but is obliged to send it. This problem of such conflict is what the present invention addresses.

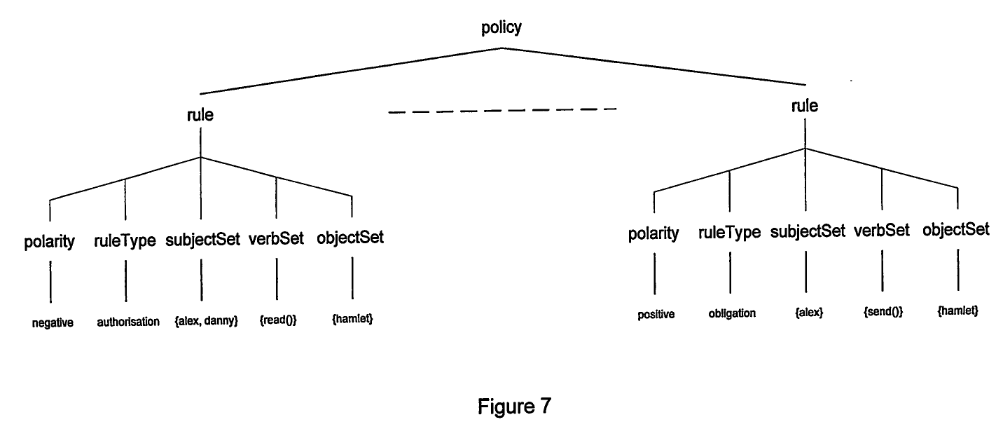

Once the user has entered the policy rules into the computer system, the policy rules may be lexically and syntactically analysed, and an internal representation of the policy can be constructed in the form of an Abstract Syntax Tree (AST). One possible AST depicting the above two rules is shown in FIG. 7. Here it will be seen that each rule is composed of five parts, being a “polarity” part, a “ruleType” part, a “subjectSet” part, a “verbSet” part, and an “objectSet” part. The polarity part may take the values positive or negative, to indicate whether the rule is expressed positively or negatively. The ruleType part may take the values authorisation or obligation to indicate whether the rule expresses something that the parties thereto are obliged to do or not to do, or are merely authorised to do or not to do. The subjectSet part takes as its value a list of one or more actors, in this case Alex and Danny. The verbSet part takes as its value a list of one or more system commands or actions, such as in this case {read( )} or {send( )}. Finally, the objectSet part takes as its value a list of one or more targets or objects upon which the subject(s) perform(s) the system command or action of the verbSet, and which in this case is {hamlet}.

What should be noticed with the above representation is that the syntax of the language Joey provides a way of grouping related policies together, so that the syntax is concerned with “subject set”, “verb set” and “object set” as opposed to a single subject acting according to a single verb on a single object. This is basically a syntactic sugar for the ease of typing in policies, but makes rule conflicts much less apparent. This problem is, however, addressed by the next step in the process provided by the embodiment.

In order to address the above, and allow for conflict detection to be performed, it is necessary to analyse the entered rules and expand the rules such that a single rule is present for each subject-verb-object combination defined by the entered rules. That is, at step 6.4 the control program 50 runs the rule expander program 52 to expand the entered rules into what we term “singleton” form, with each rule containing only a single subject, a single verb, and a single object. Therefore, a definition for the term singleton rule (which is a perfectly correct syntactic form of a rule) is given at this point as:
Mode Type: {singleSubject} {singleVerb} {singleObject};

The expander program 52 acts to convert any entered rule to a set of singleton rules. For example, consider the earlier example rule:
positive authorisation: {Danny, Alex} {read( )} {Ulysses};

which contains two values in the subjectSet list. The expander program, 52 expands such a rule to fit the singleton definition given above, to give the two singleton rules:—

positive authorisation {Danny} {read( )} {Ulysses};
positive authorisation {Alex} {read( )} {Ulysses};

Thus the expander program 52 acts to process each originally entered rule to expand the rule to provide a single rule for each subject-verb-object combination covered by the rule. Thus, as a second example, take the rule:
positive obligation {Nick, Andrei} {draft( ), review( )} {patent};

then this would be expanded to provide a singleton rule for every combination covered by the rule e.g.

positive obligation {Nick} {draft( )} {patent};
positive obligation {Nick} {review( )} {patent};
positive obligation {Andrei} {draft( )} {patent};
positive obligation {Andrei} {review( )} {patent};

More generally, the number of singleton rules in the set of rules for a policy an be calculated as:

$${\sum }_{i = 1}^{n} ( \vert {S}_{i} \vert \times \vert {V}_{i} \vert \times \vert {O}_{i} \vert )$$

where n is the number of rules (before expansion to singleton rules) in the policy.

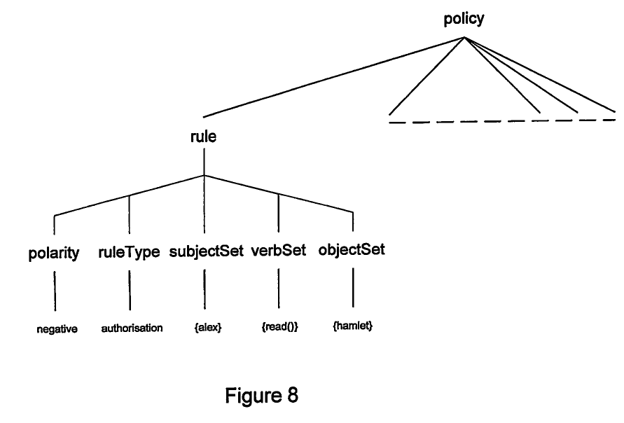

The output of the expander program 52 is therefore a list of singleton rules covering each subject-verb-object combination covered by the originally entered rules. This list is then stored for further processing. The list of singleton rules may further be graphically displayed as an AST, and an example incomplete AST showing a single singleton rule is shown in FIG. 8.

Having expanded the input rules to singleton form, the next step in the process is to receive data representing a semantic graph, at step 6.6. Thus, at step 6.6 the control program 50 launches the semantic graph program 53, which invites the user to enter data defining the various semantic relationships between the various system commands and actions which are included in the respective verbSet parts of the input rule set. The semantic relationships define the scope of the system commands and actions with respect to each other. For example, a system command {write( )} must encompass both {read( )} and {copy( )}, as in order to enable a user to perform the write( ) command on a file, the user must be able to read and/or copy the file. Whilst in the presently described embodiment the step 6.6 is depicted as occurring serially after step 6.4, it should be understood that in other embodiments in may occur at least partially in parallel, or in fact prior to the step 6.4. This is because the purpose of step 6.4 is merely to allow the user to enter the semantic relationship data, which can be performed at any stage prior to that shown in the diagram.

For the purpose of inputting the semantic relationship between the verbs as a graph, we have defined an input language which we call GraphLang. The basic elements of this are shown below:—

<graph> ::= (<nodes>)*
<nodes> ::= <nodeNames> “→” (<neighbours>)* ”;”
<nodeNames> ::= “[“ <commaSeparatedList> “]”
<neighbours> ::= <commaSeparatedList>
<commaSeparatedList> ::= <identifier > (“,” <identifier>)*

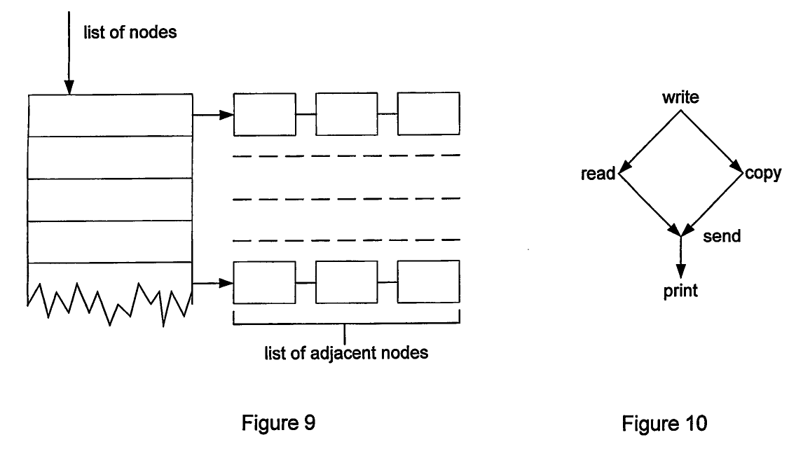

GraphLang takes as input a list of nodes and their corresponding list of adjacent/neighbour nodes. FIG. 9 illustrates the internal representation of the list of nodes and corresponding adjacent nodes, as stored in the computer memory, once entered.

Note from the language definition that nodes can have more than one name which has not been depicted in FIG. 9 for the purposes of simplification. This is due to the fact that once verbs (functions) within the system are organised into a poset some verbs fall into the same position in the graph, for example in a file system, if the system provides both “dir” (from DOS) and “Is” (from Unix). These two verbs represent the same node on the graph, because they are essentially providing the same functionality. This ability to give a node multiple names does complicate the various graph operations but essentially represents a more accurate model of the system.

As an example of an input to the GraphLang parser (the semantic graph program 53), consider the following:
[write]→read, copy;
[read]→send;
[copy]→send;
[send]→print;
[print]→;

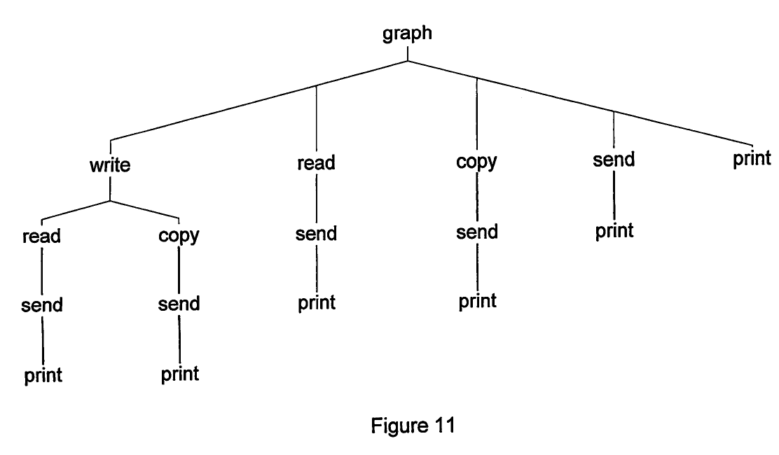

This can be represented in graphical form, as shown in FIG. 10. Another view of the graph (from the point of view of traversing down the various available paths) is shown in FIG. 11. What both FIGS. 10 and 11 illustrate are the various semantic relationships between the available system commands write( ), read( ), copy( ), send( ), and print( ). In particular the hierarchy represented in the graph tells us that if a user has permission to write( ), then she must also have permission to perform all of the read( ), copy( ), send( ), and print( ) commands. In contrast, if a user only has authorisation to read( ), then she may only perform the send( ) and print( ) commands in addition. Similarly, a user who only has copy( ) authorisation may also only send( ) and print( ) in addition, whereas a user who has only positive send( ) authorisation may only additionally print( ), but may not write( ), read( ), or copy( ). Finally, a user who only has print( ) authorisation and no other may perform no other system command except print( ).

It will be apparent from the above that the definition of the semantic relationships between the various system commands is in the hands of the human user. The GraphLang language merely allows such relationships once defined to be expressed easily in a compact and machine processable form.

Once the user has entered the semantic relationship data in GraphLang, the semantic graph program 53 preferably generates and displays the data in the form of a semantic graph as shown in FIG. 10 or 11, for the user to check if required, and preferably asks the user to indicate if the program may proceed, or to make any changes necessary. If the data is correct, the user then indicates to the program to proceed, or else makes any changes necessary to the data, and then instructs the program to proceed.

Having received the semantic graph data, the control program 50 runs the semantic expander program 54, which processes the singleton rules generated by the rule expander program 52 in accordance with the received semantic graph data so as to expand each singleton rule to give, for any particular singleton rule, an additional system operating rule for each hierarchical semantic level in the graph structure below the system command present in the particular singleton rule. This is explained further below.

More particularly, what the semantic expander program 54 does at this stage is to seek the verbSet of the singleton rules and expand the verbs using input from GraphLang. For example, consider the following singleton rule:
positive authorisation {alex} {write( )} {hamlet}

In the example, write( ) expands to send( ), copy( ), read( ) and print( ), as apparent from the semantic graph data. Thus the singleton rule given above is expanded to the following rules:—

positive authorisation {alex} {write( )} {hamlet};
positive authorisation {alex} {read( )} {hamlet};
positive authorisation {alex} {copy( )} {hamlet};
positive authorisation {alex} {send( )} {hamlet};
positive authorisation {alex} {print( )} {hamlet};

That is, because Alex had a singleton rule authorising him to perform the write( ) command on the hamlet object, he must also be able to perform all the other available system commands below the write( ) command in the semantic graph, as defined by the semantic graph data in the GraphLang format. In other words, the expansion of any verb requires the sub-graph with that particular node as its root to be traversed to collect all the nodes to which it expands, with a singleton rule being generated for each node traversed. In some case the traversal of different branches of the graph will lead to the same singleton rule being generated as previously. Such repetitious singleton rules are preferably discarded.

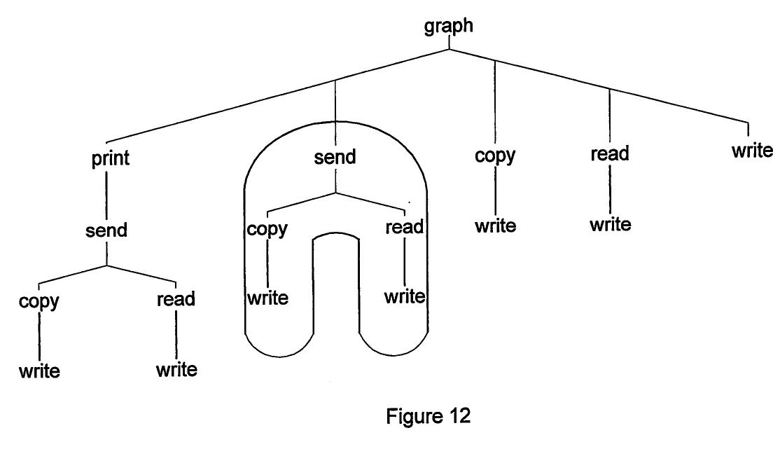

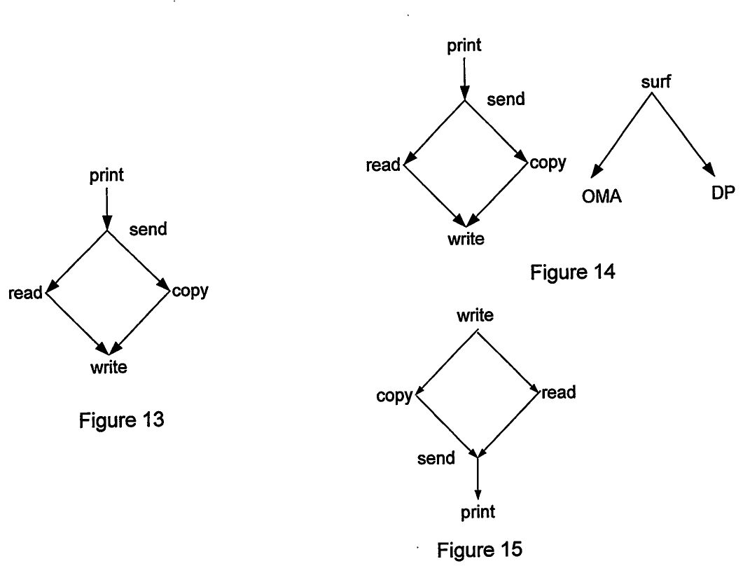

For the rules which have a negative polarity e.g. negative authorisation Danny send ( ) Hamlet, it is necessary to traverse up the graph instead of down. However, instead of devising an algorithm to do this, we have found that it is far simpler to merely create a mirror image of the graph, as below, and use the same algorithm to traverse the graph as for the positive rule case. Thus, as an example, FIG. 12 illustrates a “mirror-image” graph to FIG. 11, whence it will be seen that the paths available through the graph of FIG. 12 from top to bottom are identical to the paths available from bottom to top through the graph of FIG. 11. Similarly, with respect to the alternative graph format of FIG. 10, FIG. 13 illustrates the mirror-image graph thereto, which will be seen to be a precise mirror-image about the long axis of the page.

As an example of the negative polarity rule, consider the following policy:
negative authorisation {alex} {send( )} {hamlet}

With reference to FIG. 12 or 13, for a negative polarity rule the verb send( ) expands to send( ), copy( ), read ( ) and write ( ), traversing down the garph. Alternatively, the same expansion is obtained by traversing up each path of the graphs of FIGS. 10 and 11 from each of the send( ) nodes.

Also note that any parameters these functions have, and their dependencies on the parameters of read ( ), can be obtained from a database or a lookup table thus in the example:
negative authorisation {alex} {send( )} {hamlet}

expands to:

negative authorisation {alex} {send( )} {hamlet}
negative authorisation {alex} {copy( )} {hamlet}
negative authorisation {alex} {read( )} {hamlet}
negative authorisation {alex} {write( )} {hamlet}

Further note that the graph for a poset is a directed acyclic graph, so it is important to make sure that the input graph does not have any cycles, also that the graph is complete.

Moreover, for the purpose of the embodiment, a complete graph is defined as one in which every node mentioned as adjacent to another node (i.e. on the right hand side of the “→”) is also a node in its own right (i.e. on the left hand side of the “→”). This system will work even if there is no semantic relationship between the verbs. If a graph were incomplete it would mean that one or more verbs appeared in the adjacency list of another node (verb) but not as a node in its own right.

In order to traverse the graphs a recursive function is provided as shown below:

```
solutionSet = Ø //empty set
findImpliedVerb(currentVerb){
    solutionSet = solutionSet ∪ {currentVerb}
    for each α ∈ set of adjacent nodes of currentVerb do
    findImpliedVerb(α)
}
```

By supplying the verb which is to be expanded as the argument (currentVerb) in the function, the above function will traverse the semantic graph to find the other verbs which are sematically included in the currentVerb definition, according to the relationships ascribed thereto by the semantic graph.

The semantic expander program 54 therefor acts to expand each singleton rule generated by the rule expander program 52 to generate further singleton rules for each node in the semantic graph below the node corresponding to the verb in the particular singleton rule being expanded. The result is therefore an expanded list of singleton rules which represent, in singleton form, the entire complete rule set of the system. Such a complete rule set is required in order to be able to perform conflict detection on the rule set, as described next.

Having had the semantic expander program 54 generate the complete singleton rule set for the originally entered policies, next at step 6.10 the control program 50 runs the conflict detector program 56, which acts to process the complete singleton rule set to detect conflicts between rules contained therein. An example conflict was given earlier, where the rules:

negative authorisation : {alex, danny} {read( )} {hamlet}
positive obligation : alex {send( )} {hamlet}

meant that Alex is not allowed to read Hamlet, but is obliged to send it.

There are three types of explicit conflict which need to be detected:
1. A subject is authorised and not authorised to apply the same verb to the same object;
2. A subject is obliged and not obliged to apply the same verb to the same object; and
3. A subject is obliged but not authorised to apply the same verb to the same object.

In view of the three types of conflict, for each singleton rule in the complete set the conflict detector program searches through the following rules in the list for those rules which would directly contradict the particular rule according to the three identified types of conflict. Thus, if there are n rules in the list (R1, R2, R3, . . . , Rn), the first rule in the list is compared against each of the second rule through to last rule, the second rule is compared against each of the third rule through to last rule, the third rule is compared against each of the fourth rule through to last rule, and so on. It is not necessary to compare a rule with another rule above it in the list, as such a comparison will already have occurred when the rule higher in the list was compared with subsequent rules.

As an example of potential conflicting rules which are being searched for, consider the singleton rule:
negative authorisation: {danny} {read( )} {hamlet}

Here, the conflicting rules would be:

positive authorisation : {danny} {read( )} {hamlet}; and
positive obligation : {danny} {read( )} {hamlet}

and hence by searching for these rules in the complete rule set, any rule conflicts can be detected.

As another example, consider the singleton rule:—
positive obligation: {alex} {send( )} {hamlet}

the conflicting rules would be:

negative authorisation : {alex} {send( )} {hamlet}; and
negative obligation : {alex} {send( )} {hamlet}.

Again, by searching for either of the above two rules in the complete rule set, any conflicts with the positive obligation: {alex} {send( )} {hamlet} rule can be detected.

However, as another example, consider the rule:
positive authorisation: {alex} {send( )} {hamlet}
   Here, as Alex is positively authorised to send Hamlet it would not matter if there was a negative obligation rule in the rule set, as all a negative obligation rule would mean semantically was that Alex does not have to send Hamlet (but may do if he wants to, in which case he has authorisation). Therefore to such a rule there is only a single conflicting rule, which would be:
negative authorisation: {alex} {send( )} {hamlet}

Similarly, for the rule:
negative obligation: {alex} {send( )} {hamlet},
   as the rule imposes no requirement on Alex it would not matter what the state (positive or negative) of his authorisation was, and hence the only conflict could be with:
positive obligation: {alex} {send( )} {hamlet}.

From the above examples it will be apparent that for each rule in the complete rule set there may be one or two rules which conflict therewith, being those rules which are of the opposite polarity, and which respectively authorise or oblige the same subject to perform the same verb on the same object. By searching for such rules for each rule in the complete rule set, then all rule conflicts within the complete set can be detected.

When a conflict is detected, the rules which generated the conflict are flagged, and at step 6.12, once all the singleton rules in the complete set have been processed by the conflict detector program, the program displays the flagged rules to the user. Therefore, according to the invention conflicts within a set of system operating rules can be identified and displayed to a user.

Having displayed those rules which conflict to the user, at step 6.14 it is then up to the user to re-design the system rule set so as to avoid the conflicts. In so doing the embodiment of the invention can be used in an iterative way, by allowing new rule sets to be tested for conflicts. That is, suppose the user has come up with a new rule set which she believes resolves the identified conflicts. This may be entered into the embodiment of the invention by the control program 50 running the PBM language program 51 to allow new rules to be entered in the Joey language or to allow the existing rules to be edited. The embodiment then performs the above described process once again to identify any conflicts in the new rule set. This re-design and checking process may be repeated iteratively by the user until a rule set is found which results in no rule conflicts being identified. In this way, the embodiment of the invention may be thought of from one aspect as a design tool to aid in the design of coherent system policies or operation rules.

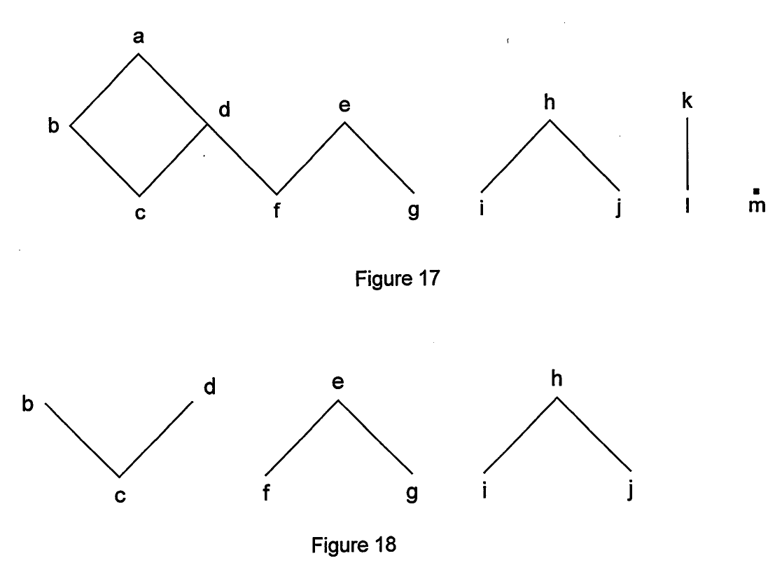

Suppose that a rule set has been entered for which no conflicts are detected. If this is the case, then at step 6.16 the control program runs the minimum set calculator program 56 to process the complete set of rules to calculate the canonical or minimum set of rules which can describe the complete set. The operation of the minimum set calculator program will be described next with respect to FIGS. 17 and 18.

Here we will examine the minimum number of actions required, using the poset structure, to express all the rules relating a subject (or a set of subjects) to an object (or a set of objects). First, let us consider the case of a subject s that can do every action on an object o. Of course, in practice no subject can do every action on a particular object and this is precisely why a semantic ordering of actions via the structure of poset is helpful as a meta-policy.

Here we define the concepts of a minimal and of a maximal element in a poset as well as an auxiliary function that will assist us in what follows. The notion of a maximal element is a notion parallel to that of a minimal element.

Definition:

Let P be a poset and B be a subset of P. An element bεB is a minimal element of B if bεB and no element b′εB exists such that b≠b′and b′

[symbol]

b

Definition:

Let P be a poset and B be a subset of P. An element bεB is a maximal element of B if b [symbol] xεB [symbol] b=x.

Now, in view of the above consider the graph G in FIG. 17 (notice here that G is not a connected graph). Here, the set of maximal elements according to the above definition is {a, e, h, k, m}, whereas the set of minimal elements according to the above definition is {c, f, g, i, j, l, m}.

In reality, however, a particular subject s does not do all the actions in the graph on a particular object o, and more likely it would only do a subset of such actions which can be represented by a sub-graph G_{S} of G. Such a sub-graph G_{S} is shown in FIG. 18. From the above definitions the maximal elements of G_{S} are {b, d, e, h}, and hence the minimum set of rules which define the actions which the particular subject s may perform on the particular object o, are in this case {b, d, e, h}.

In view of the above the minimum set calculator program 56 acts at step 6.16 to process the complete singleton rule set to sort the set into groups of rules each of which have the same subject s and the same object o. Each group of rules then defines all the actions which the subject s performs on the object o e.g. the equivalent of the graph Gs of FIG. 18. Each group of rules is then processed according to the above definitions to find the maximal elements, which then form the minimum set of rules for each group (for a more rigorous proof of the calculation of the minimum set please see Appendix A). Finally, at step 6.18, the minimum set of rules for each subject/object pair are stored. Thus, the embodiment of the invention acts additionally to find and store the canonical representation of a set of rules for each subject/object pair. The canonical representation may then be used in the future operation of the system to which the rules relate.

It should be pointed out here that the operation of the minimum rule set calculator program 56 is optional, and it is not an essential step in the operation of the invention. Where the program is not run, and the minimum set for each subject/object pair not calculated, the complete set of rules as generated by the semantic expander program 54 and checked by the conflict detector program 55 may be used as the system operating rules instead, or used as the input to a PBM code generator.

Regarding using the generated system operating rules as the operating rules of a system, it will be appreciated that any system which makes use of policy based management rule sets may make use of the conflict-resolved rule sets generated by the invention, and no particular or special characteristics are required of the system. This is because the format of the generated conflict-resolved rules will generally be the same as the rules contained in the initial rule set used as input to the conflict identification and resolution components, as will be apparent from the description of the operation of these components above.

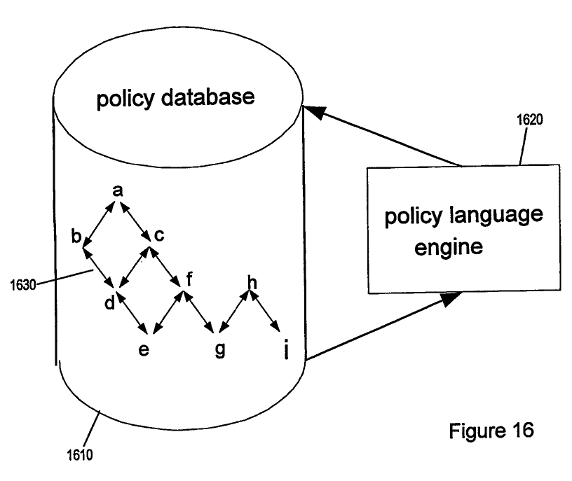

Another embodiment of the invention will now be described, which makes use of the minimum rule sets within a dynamic PBM system, which acts to give a dynamic approach. With this approach the implied rules are not added to the system. However, whenever a subject invokes a verb, on a object, the system will try to find out if the verb is permitted, by consulting some active database or lookup-table (to see if the rule was explicitly in the database). If the rule is not in the database the system will look for an ancestor (in the semantic graph sense) that implies the looked-for rule. To achieve this, the system will check the mirror image of the graph and find all the implied actions starting with the action in hand. Thus, as shown in FIG. 16, such a dynamic PBM system must comprise at least a policy engine 1620 which acts to detect a subjects invocation of a verb on an object and interface to a rule set and semantic graph 1630 for the rule set and which is stored in a policy database 1610.

As an example operation, consider the semantic graph in FIG. 14, where OLMA stands for (Online Mail Access) and DP is (Download Picture).

Suppose the following two explicit rules are the only explicit rules in the policy database 1610.

positive authorisation {alex} {send( )} {hamlet};
positive authorisation {danny} {copy( )} {hamlet};

Now if Alex wants to write hamlet, the system first consults the database to see if Alex has the authorisation to write hamlet. In this case the answer is no, so the policy engine now tries to see if Alex has authority to do any action that is ancestor to write. There are various ways of implementing this, here are two.

One way to implement this search for an ancestor can be achieved by considering the mirror image of the sub-graph headed by write and searching only this sub-graph. Such a mirror-image sub-graph for the present example is shown in FIG. 15. In this case the search of the mirror image of the sub-graph would reveal that since send (in this case also copy) is an ancestor of write and Alex is allowed to send hamlet, then Alex can write hamlet as well. The mirror image of the relevant sub-graph is dynamically generated each time. If, in the mirror image of the sub-graph headed by write, no explicitly authorised action is found, then no permission is granted. The traversing of the sub-graph can be performed using the traversal function described earlier.

A second way of achieving the search for an ancestor is by encoding the graph in the database. This can be done by having a record in the database for each action and each record containing (among other things) a field for immediate descendents (i.e. children nodes) and immediate ancestors (i.e. parent nodes) in order to traverse the graph both directions from a given node.

In summary, then, the invention provides a method and system for detecting conflicts in policy-based management rule sets. This is achieved by expanding a set of input rules such that each rule relates only to one subject performing one verb on a single object, and is known as a singleton rule. Then, data defining the semantic relationships between the different verbs is received, and this is used to further expand the singleton rules to give a complete rule set defining every possible rule according to the semantic relationships between rules. This complete set can then be processed to detect conflicts between two or more rules, and any conflicting rules are identified and displayed to a user, for the user to resolve the conflict. Additionally, the invention also provides that the rule sets may be reduced to a canonical form for compact representation thereof. A system which makes use of the conflict-resolved rule sets as its system operating rules is also intended to fall within the ambit of the invention.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

Appendix A

This Appendix examines how to identify the minimum number of verbs required, to express all the rules relating a subject (or a set of subjects) to an object (or a set of objects). First, let us consider the case of a subject s that can do every verb on a object o. Of course, in practice no subject can do every verb on a particular object and this is precisely why a semantic ordering of verbs via the structure of poset is helpful as a meta-policy.

In terms of the graph G of a poset and its mirror image Gm, the maximal elements of graph G are the minimal elements of graph Gₘ and vice versa. The function λ(G) to return the set containing the maximal elements in the graph G¹ is defined. Considering the function findImpliedVerb, it can be observed that Φ(G, λ(G))=V(G)² where V (G) is the set of vertices in the graph G. In other words only the maximal elements in the graph are needed be able to generate all the verbs. Therefore A (G) represents the minimum set that can generate the whole graph.
¹The following definition of the graph is used here:

G=(V, E) is a graph where V is the set of vertices and E is a binary relation on V i.e.
E⊂V×V
   ² The following function heading specifies the findImpliedVerb formally:
φ:: (graph×vertex)→impliedSet
   The function can be extended to accept a set of vertices and to define the following recursive function using pattern matching:
Φ:: (graph×vertices)→impliedSet
Φ(G, { })={ }
Φ(G, {v} ∪S)=φ(G, v)∪Φ(G, S)

It can be seen that 1≦|λ(G)|≦|V (G)|, when |λ(G)|=1, all the verbs within the system form a graph with one maximal element (this would include a linear chain) and when |λ(G)|=|V(G)|, there are no semantic relations between the verbs. Therefore, unless there are absolutely no semantic dependencies within the verb set in the system then |λ(G)|<|V(G)|. However, in most cases there would be some interdependency between the verbs. After all, any system, intuitively, offers a package that in its totality solves some problem. For example, consider, file management, banking, stock market, hospital management and it is inconceivable that there is a real system where verbs are not related in a semantic sense and this in turn means the maximum number of applicable rules would be equal to λ (G) and where |λ(G)|<|V(G)|.

Now, bearing in mind that the set of all verbs within the system would be very unlikely to form a connected graph, the most likely the graph would be a collection of disconnected components. Let us present the graph G of n disconnected components as G= [symbol] G₁, G₂, . . . , Gₙ [symbol] where each component Gᵢ is a connected graph. The number of maximal elements in the graph G, is equal to the sum of the number of maximal elements in each component i.e.

$$\vert λ ( G ) \vert = {\sum }_{i = 1}^{n} \vert λ ( {G}_{i} ) \vert .$$

Further refinement can be achieved by considering a more realistic case, where subject s can do all verbs in set X on object o (where X⊂G_{f})³. X can be partitioned into mutually exclusive sets X₁ X₂ . . . Xₘ such that

$$\begin{matrix}m \\ ⋃ \\ i = 1\end{matrix} {X}_{i} = X$$

and where for each Xᵢ there is a unique Gⱼ such that Xⁱ⊂Gⱼ. Let S⊂{1, . . . , n} be a set such that ∀sεS(∃iε{1, . . . , m} such that Xᵢ⊂Gₛ) also notice that for each i there is a unique s which additionally means |S|=m≦n. This would define a bijection between the elements of set {1, . . . , m} and the elements of set S. This means, the elements of set S can be enumerated by members of the set {1, . . . , m} i.e. the set S can be presented as {s₁, s₂, . . . , sₘ} Now remembering that every subset of a poset is also a poset then each Xᵢ can be represented by a graph. Indeed as Xᵢ⊂Gⱼ for some jεS then Gⁱⱼ (using the bijection, Gⁱⱼ can be represented as Gₛ_{ᵢ}ⁱ) represents the graph form of the set Xᵢ and it is a sub-graph of Gⱼ. Now whereas each Gⱼ is a connected graph the sub-graph Gₛ_{ᵢ}ⁱ might not be a connected graph and can be represented as a vector of connected components Gₛ_{ᵢ}ⁱ= [symbol] Gₛ_{ᵢ}₁ⁱ, . . . , Gₛ_{ᵢ}₂ⁱ, Gₛ_{ᵢ}ₚⁱ [symbol] where each Gₛ_{ᵢ}ₖⁱ is a connected graph. The set X can be represented by the irregular shaped two-dimensional matrix (notice, the number of components for each Gₛ_{ᵢ}ⁱ is different and the term matrix is used in a loose sense, hence, the adjective irregular). Let Gₓ be the graph representation of the set X. Also, let the sequence p₁, p₂, . . . , pₘ represent the number of components in each Gₛ_{ᵢ}ⁱ then:

$${G}_{X} = 〈 \begin{matrix}{G}_{{s}_{1} 1}^{1} & {G}_{{s}_{1} 2}^{1} & ⋯ & {G}_{{s}_{1} {p}_{1}}^{1} \\ {G}_{{s}_{2} 1}^{2} & {G}_{{s}_{2} 2}^{2} & ⋯ & {G}_{{s}_{2} {p}_{2}}^{2} \\ & & ⋮ & \\ {G}_{{s}_{m} 1}^{m} & {G}_{{s}_{m} 2}^{m} & ⋯ & {G}_{{s}_{m} {p}_{m}}^{m}\end{matrix} 〉$$

³ V(G)=G_{f} where G_{f} is the flat set that has vertices of G as its elements.

The minimum set that can generate the same set of verbs as X can do is:

$$λ ( {G}_{X} ) = λ 〈 \begin{matrix}{G}_{{s}_{1} 1}^{1} & {G}_{{s}_{1} 2}^{1} & ⋯ & {G}_{{s}_{1} {p}_{1}}^{1} \\ {G}_{{s}_{2} 1}^{2} & {G}_{{s}_{2} 2}^{2} & ⋯ & {G}_{{s}_{2} {p}_{2}}^{2} \\ & & ⋮ & \\ {G}_{{s}_{m} 1}^{m} & {G}_{{s}_{m} 2}^{m} & ⋯ & {G}_{{s}_{m} {p}_{m}}^{m}\end{matrix} 〉$$

$$λ ( {G}_{X} ) = \begin{matrix}m \\ ⋃ \\ i = 1\end{matrix} \begin{matrix}{p}_{m} \\ ⋃ \\ q = 1\end{matrix} λ ( {G}_{{s}_{q} {p}_{q}}^{1} )$$

While the size of the set of maximal elements in graph Gₓ can be calculated as;

$$\vert λ ( {G}_{X} ) \vert = \vert \begin{matrix}m \\ ⋃ \\ i = 1\end{matrix} \begin{matrix}{p}_{m} \\ ⋃ \\ q = 1\end{matrix} λ ( {G}_{{s}_{l} {p}_{q}}^{1} ) \vert$$

$$Which means \text{:} \\ = {\sum }_{i = 1}^{m} {\sum }_{q = 1}^{{p}_{m}} \vert λ ( {G}_{{s}_{l} {p}_{q}}^{1} ) \vert$$

The above quantity represents the size of the minimum set of verbs that is required to express the set of rules relating subject s to object o, that would give the same result as using the set X of verbs.

1. A method of identifying conflicts in a set of system operating rules, comprising the steps of:
a) storing rule data representing a set of one or more system operating rules, each rule comprising at least one system command;
b) receiving semantic data representing a graph structure of hierarchical semantic relationships between available system commands, including those in the set of system operating rules;
c) expanding the system operating rules according to the allowable hierarchical semantic relationships between the available system command portions, to give, for any particular system operating rule, an additional system operating rule for each hierarchical semantic level in the graph structure below the system command present in the particular rule; and
d) comparing the expanded system rules to identify those rules for which a semantic conflict occurs therebetween.

2. A method according to claim 1, wherein each stored rule comprises a subject portion identifying one or more system users, a system command portion identifying the system command to which the rule relates, and an object portion identifying one or more system objects to which the rule applies; and wherein when any of the system rules identify more than one system users in the subject portion, and/or more than one system objects in the object portion, the method further comprises expanding such rules to produce replacement rules having a single system user in the subject portion, and a single system object in the object portion, said replacement rules being produced before the expansion step c) is performed.

3. A method according to claim 1, wherein each stored rule further comprises a positive indication portion, which indicates whether the rule is to be applied positively or negatively, the method further comprising the step of producing from the semantic data a second graph structure corresponding to the inverse of the hierarchical semantic relationships between the available system commands, and wherein the expanding step c) uses the hierarchical semantic relationships of the second graph structure to expand any rules for which the positive indication portion thereof indicates are to be applied negatively.

4. A method of generating a set of system operating rules from an initial set of system operating rules, comprising the steps of:
identifying conflicts in the initial set of system operating rules using the method of claim 1; and
resolving any identified conflicts in the expanded set of initial rules to give a resolved expanded set of system operating rules.

5. A method according to claim 4, and further comprising the step of:
reducing the resolved expanded set of initial rules to canonical form to give an optimised set of system operating rules.

6. A method of operating a system comprising applying the set of system operating rules generated by claim 4 in the system operation.

7. A computer program or suite of programs arranged such that when executed by a computer it causes the computer to perform the method of claim 1.

8. A computer readable storage medium storing a computer program or suite of programs according to claim 7.

9. A system for identifying conflicts in a set of system operating rules, comprising:
a) storage means for storing rule data representing a set of one or more system operating rules, each rule comprising at least one system command;
b) data receiving means for receiving semantic data representing a graph structure of hierarchical semantic relationships between available system commands, including those in the set of system operating rules; and
c) processing means operable to:
expand the system operating rules according to the allowable hierarchical semantic relationships between the available system command portions, to give, for any particular system operating rule, an additional system operating rule for each hierarchical semantic level in the graph structure below the system command present in the particular rule; and
compare the expanded system rules to identify those rules for which a semantic conflict occurs therebetween.

10. A system according to claim 9, wherein each stored rule comprises a subject portion identifying one or more system users, a system command portion identifying the system command to which the rule relates, and an object portion identifying one or more system objects to which the rule applies; and wherein when any of the system rules identify more than one system users in the subject portion, and/or more than one system objects in the object portion, the processing means is further arranged to expand such rules to produce replacement rules having a single system user in the subject portion, and a single system object in the object portion.

11. A system according to claim 9, wherein each stored rule further comprises a positive indication portion, which indicates whether the rule is to be applied positively or negatively; and wherein the processing means is further operable to: produce from the semantic data a second graph structure corresponding to the inverse of the hierarchical semantic relationships between the available system commands; and to use the hierarchical semantic relationships of the second graph structure to expand any rules for which the positive indication portion thereof indicates are to be applied negatively.

12. A system for generating an optimised set of system operating rules from an initial set of system operating rules, comprising:
the system of claim 9; and further comprising processing means arranged to:
resolve any identified conflicts in the expanded set of initial rules to give a resolved expanded set of system operating rules.

13. A system according to claim 12, wherein the processing means is further arranged to:
reduce the resolved expanded set of initial rules to canonical form to give an optimised set of system operating rules.

14. A system arranged to operate in accordance with a set of system operating rules generated by the system of claim 12.

15. A system arranged to operate in accordance with a set of system operating rules generated by the system of claim 13.
